(19) United States
(12) Patent Application Publication
(10) Pub. No.: US 2009/0177997 A1
(43) Pub. Date: Jul. 9, 2009

(54) Populating Dynamic Navigational Content in Disparate Application Environments

(75) Inventors: Lydia Mai Do, Raleigh, NC (US); FuYi Li, Sudbury, MA (US); Pamela Ann Nesbitt, Tampa, FL (US); Lisa Anne Seacat, San Francisco, CA (US)

Correspondence Address: MOLLBORN PATENTS, INC., 2840 COLBY DRIVE, BOULDER, CO, 80305, US

(73) Assignee: International Business Machines Corporation, Armonk, NY (US)

(21) Appl. No.: 11/970,201

(22) Filed: Jan. 7, 2008

(51) Int. Cl. G06F 3/048

(52) U.S. Cl. 715/789

(57) ABSTRACT

Methods and apparatus, including computer program products, implementing and using techniques for providing document-specific widgets in an application program. An application program is launched in a digital device. A document is opened in the application program. Configuration data pertaining to document-specific widgets to be included in the application program user interface is loaded. The document-specific widgets are specific to the opened document. Each document-specific widget defining a document-specific operation to be performed with respect to the document upon activation by a user The document-specific widgets are displayed in the application program user interface and the opened document is displayed to a user of the digital device in accordance with the configuration data.

### BACKGROUND

This invention relates to web browsing. Finding desired information when navigating large document collections, such as the World Wide Web, or a large companies' internal Intranet can often be a time-consuming and challenging task, unless the identity, location, or characteristics of a specific document are well known. Generally speaking, each document is specified by a Uniform Resource Locator (URL).

Various types of navigation assistance tools have been developed to help users find particular pages, so the users do not have to remember individual URLs. Modern web browsers, that is, software applications used to view and navigate documents on the Web have introduced the concepts of “bookmarks” or “favorites.” The bookmarks and favorites allow a user to identify which documents the user would like to keep track of, and to reload and view the sites' contents at any desired time without having to remember the specific URLs. The bookmarks and favorites can be stored locally on the user's computer or on a remote server where the bookmarks can be accessed through a network, such as the Internet or an Intranet.

While bookmarks and favorites may be useful for finding particular pages, the users may still experience difficulties in navigating an individual web page when the web page has been loaded in the browser. For example, if the user is looking for “contact information” on a particular web page, the information may be located somewhere on the page itself, or it can be in the form of link or a button that redirects the user to a separate “contact information” page when the user clicks on the link or the button. The location of the link or button on the webpage may be completely arbitrarily, so the user might have to spend considerable time finding the desired contact information.

A further problem is that bookmarks and favorites are typically only available inside web browsers, so if a user is running a music application, or a word processing application, for example, the user must first switch to the web browser to access the bookmarks. Yet another problem is that for prolific web users, even bookmarks or favorite collections can get very extensive and it may be difficult to find an appropriate bookmark quickly. Thus, there is a need for improved web page navigation mechanisms.

### SUMMARY

In general, in one aspect, the invention provides methods and apparatus, including computer program products, implementing and using techniques for providing document-specific widgets in an application program. An application program is launched in a digital device. A document is opened in the application program. Configuration data pertaining to document-specific widgets to be included in the application program user interface is loaded. The document-specific widgets are specific to the opened document and each document-specific widget defines a document-specific operation to be performed with respect to the document upon activation by a user. The document-specific widgets are displayed in the application program user interface and the opened document is displayed to a user of the digital device in accordance with the configuration data.

The invention can be implemented to include one or more of the following advantages. Document-specific widgets acting as navigation elements can be included in various application programs. These document-specific widgets can be set on the fly by users, by a document that is loaded by the application program (e.g., by a web page that is loaded into a browser), or be specified by an application program developer. The document-specific widgets can vary based on the document that is displayed by the application program, so that only widgets that are pertinent to the specific document are displayed. The document-specific widgets can also vary based on the application program in which the document is displayed, so that different application programs display different sets of widgets for the same document. By enabling this additional layer of programming, a flexible approach for developers is achieved that does not exist in current technology. As a result, a uniform way is provided for users to find important links or perform operations that are relevant to a specific document, such as a website or webpage they are viewing.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a process for loading document-specific buttons in an application program in accordance with one implementation of the invention.

FIG. 2 shows an exemplary text file that includes names to be displayed on the document-specific buttons and URLs that are associated with the document-specific buttons, in accordance with one implementation of the invention.

FIG. 3 shows an example of a web browser window that includes a set of document-specific buttons in accordance with one implementation of the invention.

FIG. 4 shows an example of a conventional web browser window in which a web page is displayed.

FIG. 5 shows an example of the web browser window of FIG. 4 with added document-specific buttons in accordance with one implementation of the invention.

Like reference symbols in the various drawings indicate like elements.

### DETAILED DESCRIPTION

The various embodiments of the invention described herein pertain to enhancements to web page navigation techniques. In particular, document-specific widgets are created in response to opening documents in various application programs. The document-specific widgets may also be application-dependent, so that different widgets are shown when the same document is opened in two different applications. The widgets can represent navigational features that facilitate web page navigation for the user. The widgets can also represent actions that a user wishes to take, which may not necessarily be connected to web page navigation. For example, some widgets may cause other applications or documents to open when the user engages the widgets. Various embodiments of the invention will now be described by way of example and with reference to the drawings. In particular the following description will explain how document-specific buttons can be created in a web browser, based on a web page that is displayed in a web browser window. It should however be realized that the principles described below can be applied to any type of widgets that can be displayed in an application program, or in an application program accessory, such as a toolbar installed in a web browser.

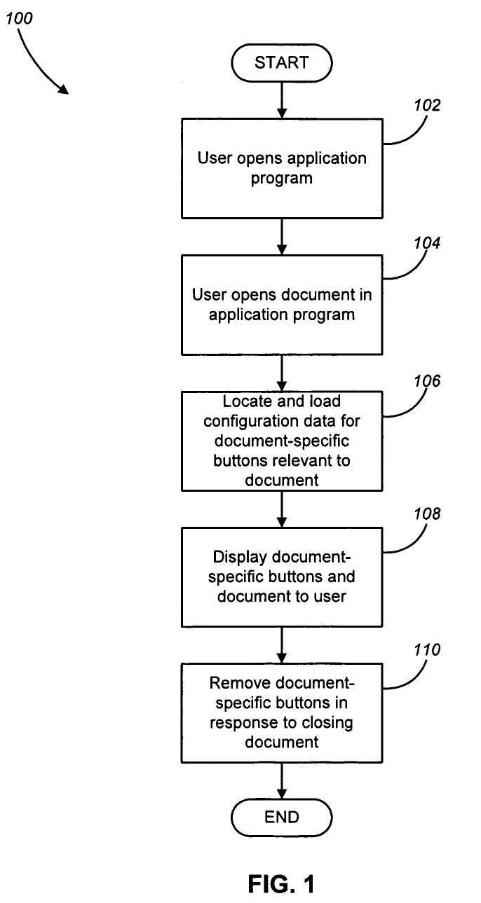

FIG. 1 shows a process (100) for loading document-specific buttons in an application program in accordance with one implementation of the invention. As shown in FIG. 1, the process (100) begins with a user launching an application program (step 102). The application program can be any type of application that can run on a digital device, such as a computer, PDA, cellular telephone, and the like. Some examples of application programs include web browsers, word processing applications, digital music or video players, calendar applications, e-mailing applications, and so on. Next, the user opens a document in the application program (step 104). It should be noted that for the purposes of this application documents include not only “conventional documents” such as word processing documents, but can also include images, web pages, music files or other types of digital content that can be saved as one or multiple files and be rendered in an application program. As the skilled person realizes, of course, the document does not have to be opened by the user. The document may very well be opened automatically by the application program as well, for example, web browsers typically load a “home page” whenever they are launched without any specific interaction from the user.

The process then locates and loads configuration data that contains information about a set of document-specific buttons relevant to the open document (step 106). Each of these document-specific buttons describes an action that is in some sense relevant for the open document. The actions that are described by the document-specific buttons can be actions that occur within the current application program or they can be actions that control functionality outside the current application program. In an application program that is not a web browser, such as a music application program, the document-specific buttons can launch, for example, various browser sessions pertaining to the piece of music that is currently being played by the music software application (i.e., the open document). A word processing application, on the other hand, can display document-specific buttons that are pertinent to the document a user is currently viewing or editing in the word processing application. For example, if a user is editing his resume in the word processing application, the document-specific buttons may include links to various websites that pertain to job listings, cost of living comparisons, and so on, that the user set up as common links they use while working with this type of document. If the user is revising a patent application, the document-specific buttons can include links to the United States Patent and Trademark Office homepage, to the law firm preparing the patent application, to company product pages pertaining to the patent application, or to various emails between the attorney and client about the contents of the patent application that the user wishes to associate with this patent application. That is, any links and/or application programs that are relevant to the specific document that is being displayed or edited can be defined. In the event that a user decides to use document-specific buttons in web browser applications only, the document-specific buttons can also be used to launch multiple mixed browser sessions, all with different document-specific buttons. For example, Internet Explorer sessions can launch other Internet Explorer sessions, or launch other applications, such as Firefox, by using the document-specific buttons. It should also be noted that in some implementations, the document-specific buttons are not only document-specific, but also application-specific. That is, if the same document is opened in two different application programs, then the two application programs may load and display different sets of document-specific buttons, where each set of buttons is specific to the particular application program.

In one implementation, the configuration data loaded in step 106 includes the names to be displayed on the document-specific buttons and URLs or applications associated with the document-specific buttons. The configuration data can be stored in various formats, such as text files, XML files, HTML files, database-driven formats, script-driven formats and so on, as can be realized by the skilled person.

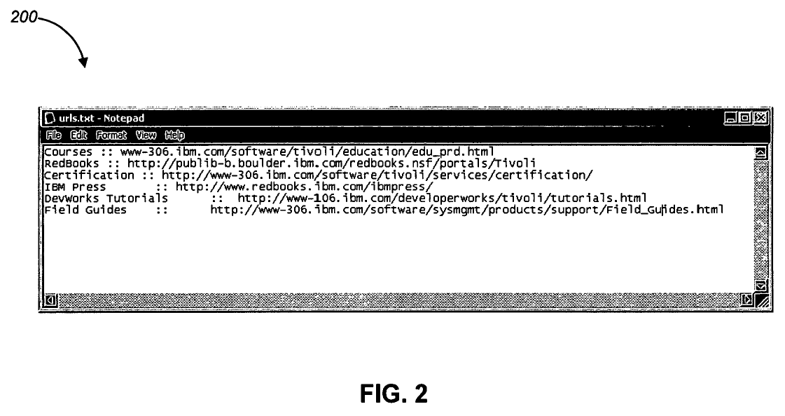

The configuration data can be locally stored on the user's computer or digital device that is used for browsing the web page, or be downloaded from a remote location in conjunction with opening the document (e.g. loading a webpage), either as a separate file or as part of the document itself. FIG. 2 shows an example of configuration data for a web page in the format of a text file (200). As can be seen in FIG. 2, the text file contains titles of document-specific buttons to be displayed in the web browser (“Courses”, “RedBooks”, “Certification”, “IBM Press”, “DevWorks T . . .” and “Field Guides) along with the respective target links that will be followed when the buttons are depressed or otherwise selected by a user.

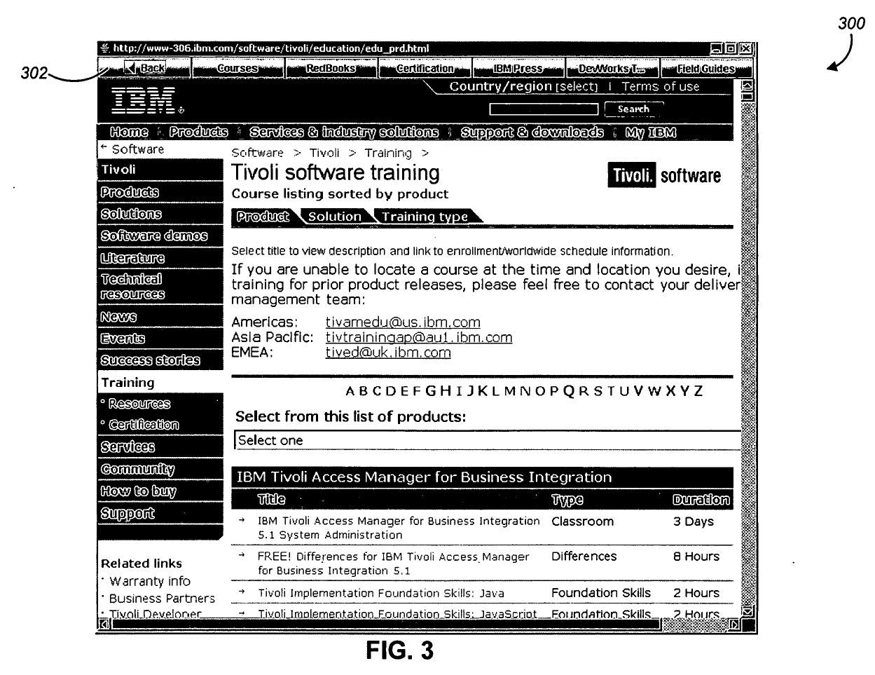

After the configuration data has been loaded, the document-specific buttons loaded by the application program are displayed by the application program to the user along with the document (step 108), so that the user can interact with the buttons using a mouse or pointing device in a conventional manner. The document-specific buttons can either be displayed as part of the application program window in which the document is displayed. In some implementations, the document-specific buttons are always displayed in the same location within the application program window, so that the user knows where to look for the document-specific buttons. In other implementations, the document-specific buttons are displayed in a window that is separate from the window in which the document is displayed, which has the advantage of not changing the original document view with which the user is familiar. FIG. 3 shows an example of a web browser window (300) that includes a set of document-specific buttons (302) that have been loaded and displayed in the manner described above, and which are described by the text file in FIG. 2. In FIG. 3, the buttons have the titles “Back”, “Courses”, “RedBooks”, “Certification”, “IBM Press”, “DevWorks T . . .” and “Field Guides.” This ends the process (100) of FIG. 1. Finally, when the user or application program closes the document or renders the document inactive, for example, by opening another document, the document-specific buttons for the closed or inactive document are removed from the application program's user interface (step 110), which ends the process (100).

It should be noted that the above process (100) can be varied in a number of ways. For example, in one implementation, there may be multiple configuration data files that describe document-specific buttons, and a set of rules can be used to determine which configuration file among the multiple configuration files should be loaded for a given document that is displayed in an application program. Some examples of rules include displaying document-specific buttons based on the document content, displaying document-specific buttons based on a URL, displaying document-specific buttons based on the application program, displaying document-specific buttons based on the time of day or the day of the week (for example, to avoid displaying “hobby-related” buttons during workdays or work hours). Essentially, any user-defined application program control can affect how the configuration data is loaded and how the widgets are displayed. For example, the application program can be set to display the document-specific widgets after a certain time delay, or automatically displaying the widgets based on some user-defined action that occurs (e.g., if a user hits play for a piece of classical music on their music player), or change the document-specific widgets based on which user is using the application program. As the skilled reader realizes, these are merely some examples and a large number of variations to these rules can be envisioned by those of ordinary skill in the art.

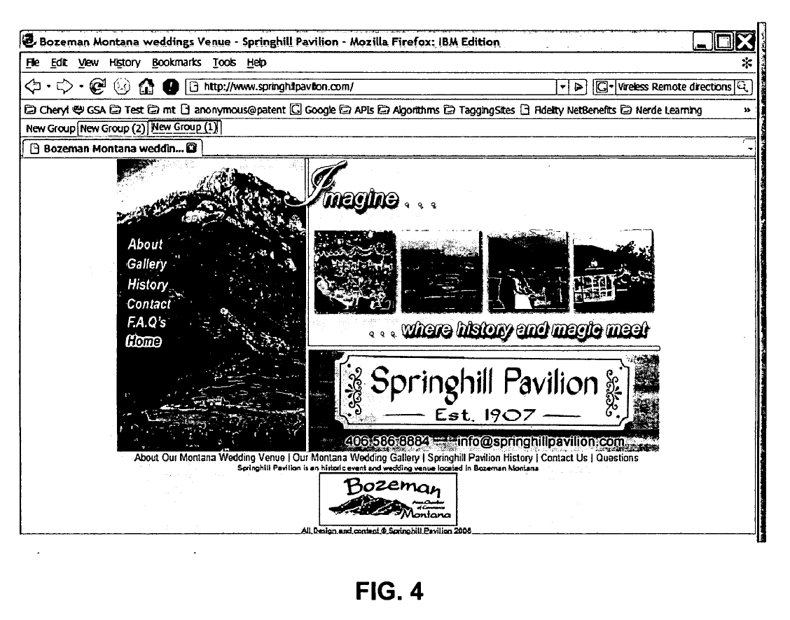

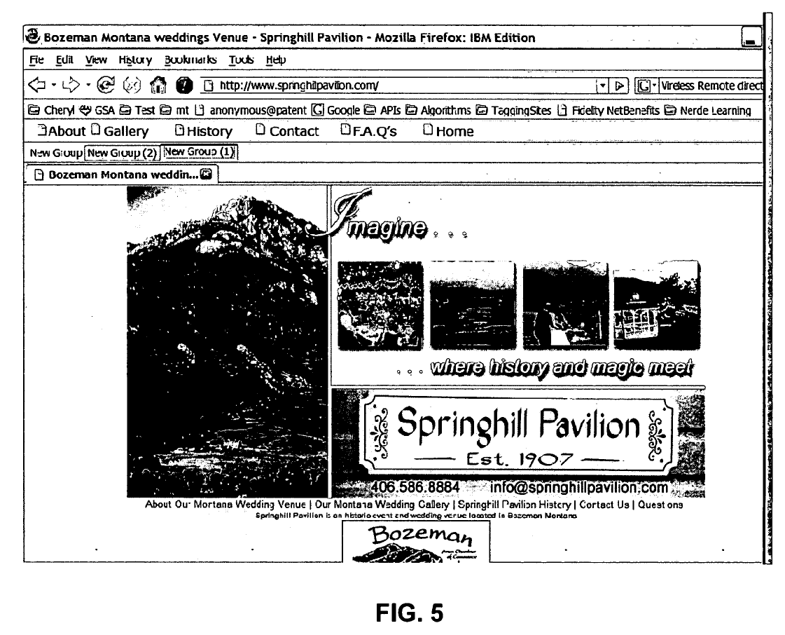

In some implementations pertaining to web browsers and web pages, a web page developer can create HTML elements that are part of the web page and that causes document-specific buttons to be created and displayed in the browser and that are specific to a particular web page or website. This technique can be used, for example, to pull page navigation elements from the web page itself and insert these elements as document-specific buttons in the web browser. As a result, the user does not need to look through the entire web page to find the navigation links, but can instead always find them in the same place in the web browser. One example that illustrates this implementation is shown in FIGS. 4 and 5.

FIG. 4 shows a conventional web page that contains a set of navigation links (About, Gallery, History, Contact, FAQs) on the left hand side and along the bottom of the web page. The web page developer can add tags representing document-specific buttons, such as

<browser-button>

<title>About</title>
<link>http://www.springhillpavillion.com/about.html</link>

</browser-button>

for the “About” link, and similar tags for the other links. These tags cause the web page to change into a web page similar to that shown in FIG. 5. As can be seen in FIG. 5, the navigation links that used to be in the left hand side of the web page have been removed and are displayed as buttons in the web browser. It should be noted that in the implementation shown in FIG. 5, the web page developer has chosen to remove the links from the left hand side on the web page, and keep the links at the bottom of the web page. However, this is merely one example of an implementation. In other implementations, all the links can be removed from the webpage and be replaced solely with the document-specific buttons in the web browser. In yet other implementations, all the original navigation links can remain in the web page and the document-specific buttons can be added simply as an additional navigational aid for the user in the web browser.

When the user navigates away from the web page shown in FIG. 5, the document-specific buttons disappear from the web browser, and will possibly be replaced by a different set of document-specific buttons defined for a different web page to which the user navigates. As the skilled reader appreciates, this is different from existing favorite and bookmark solutions, both because these document-specific buttons are created by a web page developer rather than a user browsing the page, and because the buttons change depending on what web page is being navigated rather than staying constant in the way bookmarks and favorites do. Furthermore, rather than just referring to the entire page (as is the case with bookmarks), the buttons refer to individual sections or links within the page that is displayed.

It should also be noted that in the above examples, the document-specific buttons have been described as being developed by a web page developer or a browser application developer. However, there are situations in which the users themselves can define document-specific buttons (or other types of widgets) as well, for example, by right-clicking with their mouse on a link in a web page and choosing an “Add as a document-specific button” option, which causes a button being created with the same title and target as the link selected by the user. In some implementations, the user can also edit the target and/or title associated with the button to their liking.

It should be noted again, that the document-specific buttons that are displayed are a result of developer or user configurations. This is in contrast to some existing applications that automatically create and displays links or buttons for pages or products, such as advertisements, that are “related” to the contents of the webpage that the user is currently browsing and which are typically based on keywords found on the webpage.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A number of implementations of the invention have been described. Nevertheless, it will be understood that various modifications may be made without departing from the spirit and scope of the invention. For example, the widgets have been described above as buttons, but other types of user interface elements are also possible, such as links, menus, and so on. As was described above, various types of dynamic behavior can also be included, for example, so that the document-specific buttons are only displayed as a result of a user choosing an option to have them displayed or as a result of a user right clicking somewhere in the documents with his pointing device, and so on. The buttons can be defined by an application program developer directly in the application program code, or through reading of CSS style sheets, that is, a new style button can be associated with links the application developer wants to define as important links.

In some implementations, the system can track user-level data and display document-specific buttons based on actions a particular user has taken previously with respect to the document. For example, if a user navigates to a particular webpage and always clicks a particular link on that webpage, the link can be added as a document-specific button for the webpage each time the user visits that webpage. In some implementations, the user or web developer can also create groups of links. For example, if a web developer knows that there are several ways to contact the webpage administrators, a “directory” of contact links can be created that includes a number of sub-operations, such as taking the user to a feedback form, taking the user to a page that describes a physical address for the webpage administrators, and opening an empty email addressed to the webpage administrators, and so on. Accordingly, other embodiments are within the scope of the following claims.

1. A computer-implemented method for providing document-specific widgets in an application program, the method comprising:
launching an application program in a digital device;
opening a document in the application program;
loading configuration data pertaining to document-specific widgets to be included in the application program user interface, the document-specific widgets being specific to the opened document and each document-specific widget defining a document-specific operation to be performed with respect to the document upon activation by a user; and
displaying the document-specific widgets in the application program user interface and the opened document to a user of the digital device in accordance with the configuration data.

2. The method of claim 1, wherein displaying the document-specific widgets and the opened document includes displaying the document-specific widgets in the same window as the document.

3. The method of claim 1, wherein displaying the document-specific widgets and the opened document includes displaying the document-specific widgets and the document in separate windows.

4. The method of claim 1, wherein the document includes one or more of: text, images, and multimedia components.

5. The method of claim 1, wherein:
the application program is a web browser application; and
loading configuration data includes receiving a file representing a web page to be displayed in a web browser window, the file including information about document-specific widgets for the web page and web browser application.

6. The method of claim 5, wherein the received file includes instructions to replace at least some navigational elements in the web page with document-specific widgets in the web browser application user interface.

7. The method of claim 1, further comprising:
removing the document-specific widgets from the application program user interface in response to the user taking an action causing the document to not be displayed.

8. The method of claim 1, wherein the configuration data is stored in the digital device.

9. The method of claim 1, wherein the configuration data is expressed in one of: a text format, and a programmed format operable to be loaded by the application program.

10. The method of claim 1, wherein the configuration data includes names to be displayed on the document-specific widgets and target operations to be associated with the document-specific widgets.

11. The method of claim 10, wherein the target operations include one or more of: opening a different application program, opening a file, and opening a document described by a Uniform Resource Locator.

12. The method of claim 1, wherein loading configuration data includes selecting configuration data from a plurality of configuration data sets in accordance with a pre-defined set of rules.

13. The method of claim 1, further comprising:
receiving a user input activating one of the document-specific widgets; and
performing a document-specific operation defined by the widget.

14. The method of claim 1, further comprising:
receiving a user input adding a document-specific widget for the displayed document to the application program user interface.

15. The method of claim 1, further comprising:
receiving a user-defined application control operation; and
loading configuration data in accordance with the received user-defined application control operation.

16. The method of claim 1, wherein the widgets are selected from the group consisting of: buttons, links, and menus.

17. The method of claim 1, further comprising:
loading configuration data pertaining to user-specific widgets to be included in the application program user interface, the user-specific widgets being specific to the opened document and to operations commonly performed on the document by the user; and
displaying the user-specific widgets in the application program user interface along with the document-specific widgets and the opened document to a user of the digital device in accordance with the configuration data.

18. The method of claim 1, wherein:
loading configuration data pertaining to document-specific widgets includes loading configuration data pertaining to a group of related document-specific widgets; and
displaying the document-specific widgets in the application program user interface includes displaying the related document-specific widgets as a group of widgets.

19. A computer program product comprising a computer useable medium including a computer readable program, wherein the computer readable program when executed on a computer causes the computer to:
launch an application program in a digital device;
open a document in the application program;
load configuration data pertaining to document-specific widgets to be included in the application program user interface, the document-specific widgets being specific to the opened document and each document-specific widget defining a document-specific operation to be performed with respect to the document upon activation by a user; and
display the document-specific widgets in the application program user interface and the opened document to a user of the digital device in accordance with the configuration data.

20. The computer program product of claim 19, wherein:
the application program is a web browser application; and
loading configuration data includes receiving a file representing a web page to be displayed in a web browser window, the file including information about document-specific widgets for the web page and web browser application.

21. The computer program product of claim 20, wherein the received file includes instructions to replace at least some navigational elements in the web page with document-specific widgets in the web browser application user interface.

22. The computer program product of claim 19, wherein the computer program further causes the computer to:
remove the document-specific widgets from the application program user interface in response to the user taking an action causing the document to not be displayed.

23. The computer program product of claim 19, wherein the configuration data includes names to be displayed on the document-specific widgets and target operations to be associated with the document-specific widgets.

24. The computer program product of claim 19, wherein loading configuration data includes selecting configuration data from a plurality of configuration data sets in accordance with a pre-defined set of rules.

25. The computer program product of claim 19, wherein the computer program further causes the computer to:
receive a user input adding a document-specific widget for the displayed document to the application program user interface.
